(19) United States
(12) Patent Application Publication
(10) Pub. No.: US 2005/0089251 A1
(43) Pub. Date: Apr. 28, 2005

(54) Limited wear bearing

(76) Inventor: Jerome Perrin, Versailles (FR)

Correspondence Address: HODGSON RUSS LLP, ONE M & T PLAZA, SUITE 2000, BUFFALO, NY, 14203-2391, US

(21) Appl. No.: 10/936,144

(22) Filed: Sep. 8, 2004

(30) Foreign Application Priority Data
Sep. 8, 2003 (FR) 03 10561

(51) Int. Cl. F16C 19/00

(52) U.S. Cl. 384/51

(57) ABSTRACT

The bearing, for coupling two items, comprises two rolling paths, running one in front of the other by the rolling of an interposed layer of a plurality of carrier balls which are free of any integrated mutual spacing structure and have a specific surface hardness, and it comprises a plurality of other, longitudinal spacing, balls which are interposed, free, between the carrier balls and have a surface hardness lower than the surface hardness of the carrier balls.

The invention relates to rolling bearings.

The problem-underlying the invention was associated with the use of such bearings in industries that require a high level of cleanliness, such as pharmacy, in which the lubrication or greasing of balls is excluded because of the risk of the manufactured products being contaminated by oily discharges.

It was therefore necessary to restrict the forces causing wear of the balls, that is to say the compression loading thereof between two rolling paths separated by the balls, and to limit the speed of rotation, that is to say the relative speed between those paths. Periodically it was necessary to replace the balls.

The aim of the present invention is to limit the wear of balls or the equivalent without the need for a complex assembly.

To that end, the invention relates to a bearing, for coupling two items, comprising respective two rolling paths provided for passing one in front of the other by the rolling of an interposed layer of a plurality of carrier rotating elements which have a specific surface hardness, the carrier rotating elements being free of any integrated mutual spacing structure, characterised in that the bearing comprises a plurality of other, longitudinally spacing, rotating elements, which are respectively interposed, free, between the carrier rotating elements and have a surface hardness that is lower than the surface hardness of the carrier rotating elements.

Thus, for example, in the case of balls, the bearing has an alternation of, on the one hand, carrier-type balls, which are resistant to compression and are in contact with the two paths by way of two punctiform summit segments of a sphere, i.e. domes, that are opposite to one another in the transverse direction of the thickness of the bearing, the thickness corresponding to the value of the diameter of the carrier balls and, on the other hand, balls of the longitudinal spacing kind which are less hard, thereby preventing any mutual contact between the lateral sphere segments, which face one another but are mutually spaced, of the carrier balls.

Any friction is thereby inhibited between the facing lateral sphere segments, of two neighbouring carrier rotating elements, which have speeds of the same transverse direction but of opposite senses, which are thereby mutually spaced. Furthermore, since the carrier rotating elements roll over the two paths, the only case where there may be a residue of slippage of the rotating elements at those paths corresponds to the case in which the two rolling surfaces may not be of exactly the same length, by being, for example, concentric.

No integrated structure, such as a chain of cages or shafts, is therefore necessary for maintaining a lateral space, that is to say longitudinal in relation to a direction of extension of the paths, between the carrier balls, which simplifies the assembly. The carrier balls are free laterally in the space defined transversely by the two paths, and the spacer balls are in the same way free laterally and optionally transversely if their diameter is less that that of the carrier balls.

Between two carrier rotating elements there may be provided one or more spacer rotating elements, that is to say that the plurality of spacer rotating elements may be greater than the plurality of carrier rotating elements, Thus, if desired, several spacer rotating elements may be interposed between any two neighbouring carrier rotating elements in a laterally adjacent and/or superposed manner, that is to say approximately in transverse alignment, with diameters, which may or may not be mutually identical, that are smaller that the diameter of the carrier rotating elements.

Hence to solve the problem of resistance to wear, applicant led its research in a direction totally opposite to that which seemed rational, since the solution presented here consists in, on the one hand, allowing contact between rotating elements of different types and, on the other hand, providing the spacer rotating elements with a lower hardness, that is to say sacrificing them in order to preserve the carrier rotating elements. As it is easy to make provision for the spacer rotating elements to ensure, initially, a lateral spacing that exceeds a threshold value, those elements continue to ensure a padding function in order to keep out of contact with one another the lateral sphere segments of the carrier rotating elements, even in the event of significant wear of the spacer rotating elements.

The spacer rotating elements thus constitute the lateral walls of an imaginary cage, mobile in longitudinal translation and rotated by the action of carrier rotating elements which push them back sideways, but the spacer elements restrict the longitudinal relative movement, that is to say the lateral spacing, between the carrier rotating elements themselves, without, however, restricting the absolute movement of rotation and of translation of the carrier rotating elements in relation to the paths.

The two types of rotating elements described above may be balls, cylindrical or ovoid rollers, or any other element of approximately circular cross-section, that are resistant to compression, the two types being of identical or different shape in any desired form of realisation.

Advantageously, the carrier rotating elements have a surface hardness greater than a determined surface hardness of the paths.

Any wear of the carrier rotating elements is thus limited, so that they retain a good surface condition and hence alleviate the wear of the spacer rotating elements.

The carrier rotating elements are preferably metallic and the spacer rotating elements may be of plastics material. Provision for the latter to be formed by a hard, for example metallic, nucleus, carrying a layer of soft material of a plastics kind is not, however, excluded.

The carrier rotating elements advantageously have a Vickers surface hardness greater than 2000 VH.

In order to limit their respective wear, the rotating elements, carrier and spacer respectively, preferably have a mutual coefficient of friction of less than 0.04.

In one embodiment, the carrier rotating elements and the spacer rotating elements are approximately of a same radius.

The two rolling paths may belong respectively to a threaded bolt and a nut of a screw-bolt constituting a bearing, which is connected to a conduit for putting back into circulation the various rotating elements, the conduit connecting a downstream end of a portion of the paths to an upstream end of the portion.

In one particular embodiment, the spacer rotating elements have a profile of which a portion is complementary to a portion of a profile exhibited by the carrier rotating elements.

The carrier and spacer rotating elements respectively are thus in contact by way of a surface, which limits the compression pressure, between two of the carrier rotating elements, to which each spacer rotating element is subjected.

The paths may each have a transverse profile comprising a relief having a shape complementary to a shape of a relief of a profile of at least one of the two pluralities from the group constituting the plurality of the carrier rotating elements and the plurality of the spacer rotating elements.

One of the reliefs, i.e. a positive or a negative contour, thus constitutes, for the other relief, a longitudinal guide rail along the paths.

In particular, therefore, the spacer rotating elements may be balls having one or two or, preferably, three diametric grooves, in respective approximately orthogonal planes, it being possible for one of the grooves thus to act as an annex, i.e. additional, rolling path for two adjacent carrier balls, whilst spherical surface zones of the spacer ball may be supported on raised edges at each side of the paths so as thereby to guide the combination of the two types of balls while keeping them centred in relation to the path edges. The spacer ball thus has a central nucleus having eight protuberances equi-distributed like the corners of a cube.

The invention will be better understood by way of the following description of a preferred embodiment of the bearing of the invention with reference to the accompanying drawing in which:

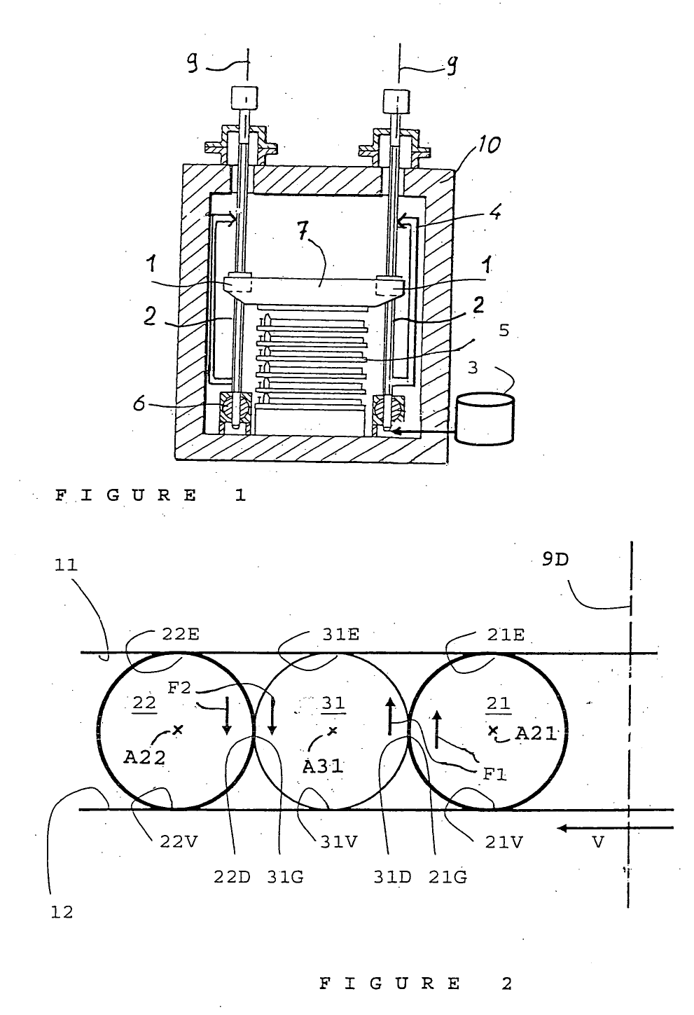

FIG. 1 is a diagrammatic vertical section of a container, here a cupboard, comprising a rolling bearing mechanism according to the invention and

FIG. 2 is a vertical section of a portion of the bearing, showing rotating elements of the bearing.

FIG. 1 is a diagrammatic representation of an “elevator” mechanism for the vertical translation of a plurality of shelves 5 in a container 10, which in this case is a cupboard formed as a lyophilisation vessel. The invention is clearly not restricted to this particular application.

The mechanism forms a gantry comprising two rotating columns having vertical geometric axes 9, which columns extend inside the container 10 over the entire height of each side and are provided with a screw thread so as to constitute, respectively, two carrier threaded bolts 2 for the support, guidance and vertical drive of a horizontal beam 7, two opposing ends of which beam 7 comprise, for that purpose, two respective holes having an internal thread, constituting two nuts 1, carried, in this case in fixed position with regard to rotation, respectively coupled to two threaded bolts 2, which carry them. The shelves 5 are suspended from the beam 7 by a chain of articulated connecting rods, not shown, that enable the assembly of shelves 5 to be opened out for bottles to be placed therein, and then closed up again by means of descent of the beam 7, in order to attach stoppers to each of them, in a single operation. A lower end of each threaded bolt 2 is carried by a support nut 6 having no thread pitch. A common drive 3 causes the threaded bolts 2 to rotate in the desired direction.

A possible variation is for the two nuts 1 to be rotatably mounted and connected to a drive in order to cooperate with threaded bolts 2 which would be completely fixed. Another possibility is a dual assembly in which the two threaded bolts 2 are replaced by carrier nuts that rotate or are fixed in respect of rotation.

Each assembly formed by a nut 1 and the associated threaded bolt 2 thus forms a screw 1, 2 constituting a bearing that has two helical paths axially in opposition, and the pair of screws so formed drives the shelves 5, it nevertheless being possible in another example for the duplication of the screws 1, 2 described here not to be provided.

A conduit 4 ensures that various rotating elements of the bearing, which are shown diagrammatically in FIG. 2, are put back into circulation, i.e. recycled. The conduit 4 connects one portion, in this case a downstream end or outlet portion, of each screw 1, 2 to an upstream portion, in this case an inlet end portion. Given that such an assembly with ball recirculation is described in the catalogue of the German company Korta, a more detailed description here is superfluous.

FIG. 2 shows, brought back in a plan view, the drawing of an approximately vertical circular section of an angular sector, or portion, of the helical bearing of FIG. 1. The section is along an approximately cylindrical surface centred on one of the axes 9 and of a radius provided for passing approximately at radial mid-height of two cooperating threads of, respectively, the nut 1 and the associated threaded bolt 2, each having approximately “V”-shaped profiles which are mutually interlaced, that is to say interleaved, open towards the axis 9, that is to say towards the front of FIG. 2. The broken vertical line 9D in FIG. 2 merely illustrates the direction of the axis 9 and not its true position. An upper branch of such a “V”, female, defined by the thread profile of the nut 1, carried, is thus supported on an upper branch of a V, male, defined by the thread profile of the threaded bolt 2, carrier, which is set in the female “V”. The above mentioned two upper branches are thus functional branches, whilst two lower branches of the two respective “V”s, female and male, which run mutually spaced, one in front of the other, during rotation, do not have a support function given that, in this example, only gravity is acting.

Hence a rolling path 11, carried, is provided on the upper branch of the female “V”, that is to say on the upper flank of the thread profile of the nut 1, the path 11 thus being turned partly downwards and also towards the axis 9. An associated rolling path 12, carrier, is provided on the upper branch of the male “V”, in parallel facing and below the path 11, that is so say that the path 12 is located on a carrier flank at a lower level in relation to the flank carrying the path 11, the carrier flank being defined by the thread profile of the threaded bolt 2, carrier. The path 12 is thus turned partly upwards and also in a direction somewhat opposite to the axis 9. The section of FIG. 2 thus passes through points of momentary contact, top and bottom, between carrier balls 21, 22, which are described hereinafter, and the paths 11 and 12, which they maintain mutually spaced. The paths 11, 12 thus define a helical channel in which the carrier balls, although compressed transversely, nevertheless tend to move downwards as a result of gravity.

The path 12 of the rotating threaded bolt 2 has a linear speed V (indicated by an arrow V which in this case is oriented to the left) of displacement parallel to the path 11 of the nut 1 which is fixed in rotation.

Interposed between the paths 11 and 12, and over the whole of the length thereof, is a plurality of rotating elements of the carrier type having circular sections of the same diameter. The carrier rotating elements, of which only two are shown, are in this case carrier balls 21, 22 having a specific surface hardness which is chosen to be relatively high, that is to say higher than a minimum threshold value. In this example it is steel that has been subject to a surface treatment to incorporate a wear-resistant material for the purpose of retaining a very high finish.

The carrier balls 21, 22 turn about respective geometric axes 21A and 22A that have so-called radial directions, that is to say that pass through the axis 9 and which are perpendicular to the plane of FIG. 2. The above-mentioned top points of momentary contact of the carrier rotating balls 21, 22 on the path 11 have the respective references 21E and 22E, while the opposite bottom points of momentary contact on the path 12 have the references 21V and 22V.

A gentle longitudinal incline of the paths 11, 12 in relation to a direction normal to the axis 9 determines, over one turn of the threaded bolt 2, an axial advance defining a thread pitch, not shown in FIG. 2. The paths 11, 12 of the upper functional branches of each of the two complementary “V” profiles have an oblique angle, that is to say an incline in relation to a radial to the axis 9, which means that the alignment of the two opposed points of momentary contact 21E, 21V, and 22E, 22V, respectively, of each carrier ball 21, 22 is inclined to the same extent on the axis 9. As a result, in order that the section of FIG. 2 passes exactly, as shown, through the above-mentioned opposite points of momentary contact, the section surface is, in fact, generated by an upwardly inclined line segment on the axis 9 of an angle equal to the oblique angle, and being helically displaced along the axis 9 according the thread pitch.

In another example, the balls 21, 22, which in this case constitute the rotating elements, can be replaced by rollers which are in contact with the paths 11, 12 along a generatrix. Each roller may be of almost constant radius if each path 11, 12 is transversely rectilinear, as in this case, but with, in this example, a radial profile, that is to say along a section through a plane containing the axis 21A or 22A, having a slight conicity opening radially outwards to compensate for the increase in length of each path 11, 12 as a function of the spacing from the axis 9, starting from a respective radially internal edge of each path 11, 12. The radius of the rollers may, however, vary according to a corresponding axial running position i.e. any choosen position on the lengh of the axis 21A or 22A, if the paths 11, 12 have a curved transverse profile.

The carrier rotating elements may in particular have a radial profile which is convex or concave over certain portions of their length along the axis 21A, 22A. This profile can thus be hollowed out in a V or any other shape, for example in the shape of two “C”s back to back, or two frusta of a cone joined by their bases or their apices, the paths 11, 12 being of complementary shape thus conforming to that radial profile, which hence has a radially intermediate, for example radially central, region, which is narrowed, that is to say in, or close to, the plane of intersection of FIG. 2. Such a narrowed radial profile has the advantage of maintaining the carrier rotating elements in the desired transverse direction perpendicular to the plane of FIG. 2. Indeed, in the case of transverse misalignment of the carrier rotating elements, end portions thereof, situated at the ends of the axis 21A or 22A and of increased diameter in relation to a diameter value of the contiguous apices of the cone frusta, would be brought back towards a radially intermediate portion, of the channel, with a profile adjusted to the narrowed profile of the radially intermediate portion of the carrier rotating elements, that is to say approximately towards the plane of FIG. 2. The radially intermediate portion of the channel thus being of minimum axial height between the paths 11, 12, the latter would impose an axial force of increased pressure on the carrier rotating element in question which, as a result of wedging effect, would thus tend to reassume the desired radial alignment in relation to the axis 9. In the present example, the radial profile of the paths 11 and 12 could thus, as a variation, have a curvature similar or indeed equal to that of the carrier balls 21, 22.

Another plurality, not shown in full, of rotating elements of a different type, to be exact of a “spacer” type, is similarly-distributed over the whole of the length of the channel between the paths 11, 12, each such spacer rotating element being interposed between two carrier balls, such as the carrier balls 21 and 22, and hence longitudinally in the bearing, in order to avoid frictional mutual contact at the level of lateral points mutually opposite at mid-height, 21G, on the left for the carrier ball 21, and 22D, on the right for the carrier ball 22. Those lateral points could even be lateral segments of a sphere if the contact between the carrier balls 21, 22 were not thereby avoided. The only spacer rotating element represented is, in this case, a spacer ball 31 which, in this example, has a diameter approximately equal to, or slightly smaller than, that of the carrier balls 21 and 22. The spacer ball 31 has a surface hardness lower than that of the carrier balls 21, 22. Indeed the spacer ball 31 is, in this case, made of plastics material. The spacer ball 31 turns about a geometric axis 31A having a so-called radial direction, that is to say passing through the axis 9 and perpendicular to the plane of FIG. 2.

The paths 11, 12 and the carrier balls 21, 22 are in this case made of martensite stainless steel having been subjected to a DLC (diamond-like carbon) surface treatment, whilst the spacer balls 31 are made of Teflon, PTFE. The Vickers hardness of the paths 11, 12 is approximately 800 VH, and that of the carrier balls 21, 22 is higher and is approximately 900 VH, the hardness of their surface treatment being even higher and in this case being 3000 VH. The Brinell hardness of the spacer balls 31 is in this case approximately 30 KH according to DIN standard 53 456. The coefficient of friction between a carrier ball 21 (or 22) and, respectively, a path 11 (or 12) and a spacer ball 31, is from 0.1 to 0.2, and, respectively, less than 0.04.

The references 31E and 31V designate opposite points of momentary contact, that is to say “top” and “bottom” “running” contact, respectively, between the spacer ball 31 and the paths 11 and 12, respectively, and the references 31D and 31G designate lateral mid-height points to the right and left, respectively, in contact with the so-called mid-height lateral points to the left, 21G, and to the right, 22D, of the respective carrier balls 21 and 22, those various points of contact being, in fact, small surfaces in the form of segments of a sphere.

The details of operation of the elements of the bearing will now be described.

When the path 12 of the rotating threaded bolt 2 passes in front of the path 11, the carrier balls 21, 22 tend to be driven in rotation, here in the sense of the hands of a watch, up to an angular speed for which their momentary points of contact 21V and 22V have a relative linear speed of zero in relation to the path 12, that is to say the speed V for rolling without slipping. The same applies for their momentary points of contact 21E and 22E with the fixed path

The spacer ball 31 may have various movements, according to the forces to which it is subject. Thus, in the case of longitudinal compression by carrier balls 21, 22 that are tending to draw closer to each other, the spacer ball 31 tends to turn in the opposite direction to that of the carrier balls 21, 22. Indeed the lateral point 31D, in contact with the lateral point 21G, is driven by the latter at the linear speed V, which is common to the lateral point 21G and to the path 12, the speed of the lateral point 21G being, however, ascending, according to arrow F1. Symmetrically, in relation to the centre of the spacer ball 31, the lateral point 22D, in contact with the lateral point 31G, drives by friction the lateral point 31G at speed V, vertically downwards, according to arrow F2. As a result, the spacer ball 31 runs virtually without slipping on the carrier balls 21, 22, which assists in avoiding wear.

One of the points of momentary contact 31E and 31V, or both of them, is likely to rub against the facing path 11, 12. The friction is, however, under gentle pressure, since the spacer ball 31 is not “carrying”. The spacer ball 31 is essentially subject only to longitudinal forces from the carrier balls 21, 22, transverse forces towards one of the paths 11, 12 being excluded, since the spacer ball 31 is here approximately of the same dimension as the carrier balls 21, 22, and is thus not pushed back vertically towards one of the two paths 11, 12 by wedging effect. Its friction on the paths 11, 12 is thus reduced.

One variation provides that, for the spacer rotating elements, the spacer balls 31 are replaced by cylindrical rollers or rollers of variable concave or convex section, for example approximately frusta of a cone having joined bases or apices, as described hereinabove for the carrier balls 21, 22. In the case of carrier rotating elements having a bulbous or narrowed form in a radially intermediate portion, that is to say in an approximately central portion intersected by the plane of FIG. 2 which intersects the axes 21A, 22A at mid-length, provision may be made for the paths 11, 12 to have a radial profile complementary to that of the carrier rotating elements only over a portion of the length of the axes 21A and 22A, which correspond approximately to the width of the paths 11, 12, so that the spacer rotating elements can have, over the remainder of the length of the axes 21A, 22A, a radial profile complementary to that of the carrier rotating elements or of the paths 11, 12. For example, the radial profile of the paths 11, 12 may be provided in order that the spacer rotating elements comprise two opposing flared regions, which are approximately in the shape of a frustum of a cone at each respective end of the axis 31A, or in any other shape, in order to come into contact with the two corresponding ends, of the associated carrier rotating elements, having a radial profile which, along the axis 21A or 22A, tapers in a manner complementary to the said flared regions. Such flared regions thus increase the axial contact length between the carrier rotating elements and the spacer rotating elements and furthermore constitute a mass of reserve material subjected, through the carrier rotating elements, to compression forces smaller than the material situated in the radially intermediate portion. In effect, in the event of two carrier rotating elements coming closer, the above two flared regions, which have a wedge profile, are able readily to move radially in relation to the axis 9, that is to say parallel to the axis 31A towards the respectively radially internal and radially external edges of the channel.

In particular, provision may be made for the intermediate portion of the spacer ball 31, in section in FIG. 2, to have a reduced diameter so that, at each end of the axis 31A, only the above two flared regions, then having a profile of a trumpet cone, are, over the whole of their length, in contact with a surface strip of the carrier balls 21 and 22 by way of their contour in an arc of a circle having a radius of curvature corresponding to the radius of the carrier balls 21, 22.

More generally, starting with a spacer ball such as the ball 31, which here has a diameter approximately equal to that of the carrier balls 21, 22, provision may be made for the spacer ball 31 to have a groove in diametric position in any desired plane, the groove being bounded by two opposing flanks having a profile corresponding to the radius of the carrier balls 21, 22, and comprising a groove base which, optionally, is recessed so as not to be in contact with the lateral points 21G and 22D. Given the fact that the balls are recycled by the conduit 4 in a random orientation, a second such diametric groove may be provided, preferably in a plane perpendicular to the plane of the above first groove, and even optionally a third diametric groove too, also preferably in a plane perpendicular to the respective planes of the first and second grooves. Consequently, the spacer ball 31 so modified readily takes up, at the outlet of the conduit 4, an orientation as described above. In addition, if the paths 11, 12 have raised edges so that the channel of balls is of circular cross-section corresponding to that of the original balls 21, 22 and 31, retained spherical surface portions of the original ball 31, i.e. surfaces except said grooves, serve, at each end of the axis 31A, to rest against the raised edges of the paths 11 and/or 12 so as thereby to prevent any importune translation of the spacer ball 31 along the axis 31A. The carrier balls 21, 22 are thus themselves centred in the same way on the paths 11, 12 via the intermediary of spacer balls 31.

In this example, as indicated the surface hardness of the paths 11, 12 is lower than that of the carrier balls 21, 22. This has the advantage of preserving the surface quality of the carrier balls 21, 22, and thus limits the rate at which wear of the spacer ball 31 occurs as a result of abrasion on the former, wear which is due to the fact that, even driven at the speed F1, F2 of the carrier balls 21, 22, the spacer ball 31 is longitudinally compressed in variable manner on the latter, which may cause wear if the quality of the surfaces of the carrier balls 21, 22 is inadequate.

The conduit 4, which ensures that the channel of balls formed by the paths 11, 12 reloops on itself, thus avoids any excessive lateral compression of the various rotating elements, such as the carrier balls 21, 22, and the spacer balls, such as the spacer ball 31. Since these are balls, and are thus of a shape that does not have a specific orientation to maintain, the conduit 4 is in the form of a tube having a circular internal cross-section. In the case of shapes elongated along an axis of rotation, the conduit 4 would have a corresponding cross-section in order to maintain the desired orientation of the axis, or would at least comprise in the upper portion an outlet opening conforming in that respect, as described for the channel.

1. Bearing, which couples two elements, comprising two respective rolling paths provided for passing one in front of the other by the rolling of an interposed layer of a plurality of carrier rotating elements which have a specific surface hardness and which are free of any integrated mutual spacing structure, characterised in that the bearing comprises a plurality of other, longitudinally spacing, rotating elements, which are respectively interposed, free, between the carrier rotating elements and have a surface hardness that is lower than the surface hardness of the carrier rotating elements.

2. Bearing according to claim 1, wherein the carrier rotating elements have a surface hardness greater than that of the paths.

3. Bearing according to claim 1, wherein the spacer rotating elements are made of plastics material, the carrier rotating elements being metallic.

4. Bearing according to claim 1, wherein the carrier rotating elements have a Vickers surface hardness greater than 2000 VH.

5. Bearing according to claim 1, wherein the rotating elements, carrier and spacer respectively, have a mutual coefficient of abrasion of less than 0.04.

6. Bearing according to claim 1, wherein the carrier rotating elements and the spacer rotating elements have approximately the same radius.

7. Bearing according to claim 1, wherein several spacer rotating elements are interposed between any two adjacent carrier rotating elements.

8. Bearing according to claim 1, wherein the two rolling paths belong respectively to a threaded bolt and a nut of a screw connected to a conduit for putting carrier rotating elements and spacer rotating elements back into circulation, which conduit connects a downstream end of a portion of the paths to an upstream end of the portion.

9. Bearing according to claim 1, wherein the spacer rotating elements have a profile of which a portion is complementary to a portion of a profile exhibited by the carrier rotating elements.

10. Bearing according to claim 1, wherein the rolling paths each have a transverse profile comprising contours of a shape complementary to the shape of the contours of the profile of at least one of the two pluralities of the group formed by the plurality of the carrier rotating elements and the plurality of the spacer rotating elements.

11. Bearing according to claim 1, wherein the spacer rotating elements are freely rotating balls.

12. Bearing according to claim 11, wherein the balls constituting the spacer rotating elements have three diametric grooves in respective approximately orthogonal planes.

13. Bearing according to claim 1, wherein the carrier rotating elements are balls.
